(19) United States
(12) Patent Application Publication
(10) Pub. No.: US 2026/0077493 A1
(43) Pub. Date: Mar. 19, 2026

(54) ROBOT TEACHING CONSOLE AND ROBOT CONTROL SYSTEM

(71) Applicant: FANUC CORPORATION, Minamitsuru-gun, Yamanashi (JP)

(72) Inventor: Kai SHIMOTSUMA, Yamanashi (JP)

(73) Assignee: FANUC CORPORATION, Minamitsuru-gun, Yamanashi (JP)

(21) Appl. No.: 19/110,352

(22) PCT Filed: Oct. 25, 2022
(86) PCT No.: PCT/JP2022/039657

§ 371 Date: Mar. 10, 2025

(51) Int. Cl. B25J 9/16; G06F 8/65

(52) U.S. Cl. CPC B25J 9/1656; B25J 9/161; G06F 8/65

(57) ABSTRACT

A robot teaching console according to one embodiment has a function for communicating with only a robot control device, the robot teaching console providing an interface with a user. The robot teaching console: acquires, from a network via the robot control device by using an acquisition unit, update data pertaining to software being executed by a host device; and saves the update data in a storage unit. When an update processing program for updating the software is activated by using an activation unit, the robot teaching console updates the software on the basis of the update data saved in the storage unit and in accordance with the update processing program by using an updating unit.

### TECHNICAL FIELD

Embodiments described herein relate generally to a robot teaching pendant for teaching a robot or operating the robot via a robot control device, and a robot control system.

### BACKGROUND ART

In the related art, robot teaching pendants are used which are each communicably connected to a robot control device for controlling the operation of an industrial robot (hereinafter, also simply referred to as a robot) and provides a user interface for teaching the operation of the robot or operating the robot.

### CITATION LIST

### Patent Document

Patent Document 1: Japanese Unexamined Patent Application, Publication No. 2006-142480

### DISCLOSURE OF THE INVENTION

### Problems to be Solved by the Invention

In general, a dedicated operating system (OS) is installed in a robot teaching pendant, and various application programs are executed on the OS to provide functions such as reception of user inputs, a command to a control device, and acquisition and display of information from the control device.

However, when the OS or the application program needs to be updated such as security update or version upgrade, it has been difficult to rewrite the software because the robot teaching pendant is connected only to the robot control device. For example, since it is necessary to prepare a storage device such as USB memory or an SD card and store an update program (special OS image or application program), an update file, and the like, there has been a risk of software failure due to an operation error or rewriting by a third party. Therefore, a method of updating software more easily and safely is desired.

### Means for Solving the Problems

A robot teaching pendant according to an embodiment has a function of communicating only with a robot control device, and provides an interface for a user. The robot teaching pendant acquires update data of software to be executed by the robot teaching pendant from a network via the robot control device by an acquisition unit, and stores the update data into a storage unit. When an update processing program for updating the software is activated by an activation unit, the robot teaching pendant updates the software based on the update data stored in the storage unit in accordance with the update processing program by an update unit.

A robot control system according to an embodiment includes a robot control device and a robot teaching pendant that communicates only with the robot control device, and provides an interface for a user. In response to a request from the robot teaching pendant, the robot control device acquires update data of software to be executed by the robot teaching pendant from a network by a communication control unit, and transmits the update data to the robot teaching pendant. The robot teaching pendant acquires the update data by an acquisition unit via the robot control device, and stores the update data in a storage unit. When an update processing program for updating the software is activated by an activation unit, the robot teaching pendant updates the software based on the update data stored in the storage unit in accordance with the update processing program by an update unit.

### BRIEF DESCRIPTION OF THE DRAWINGS

FIG. 1 is a block diagram illustrating a functional configuration of a robot control system according to an embodiment;

FIG. 2 is a diagram illustrating a flow of processing in which an OS of a robot teaching pendant is updated by the robot control system according to the embodiment; and

FIG. 3 is a flowchart illustrating software update processing according to the embodiment.

### PREFERRED MODE FOR CARRYING OUT THE INVENTION

Hereinafter, an example of an embodiment of the present invention will be described. A robot teaching pendant of the present embodiment is a device that provides a user interface with a robot control device that controls the operation of a robot, and is communicably connected in a wired or wireless manner to constitute a robot control system.

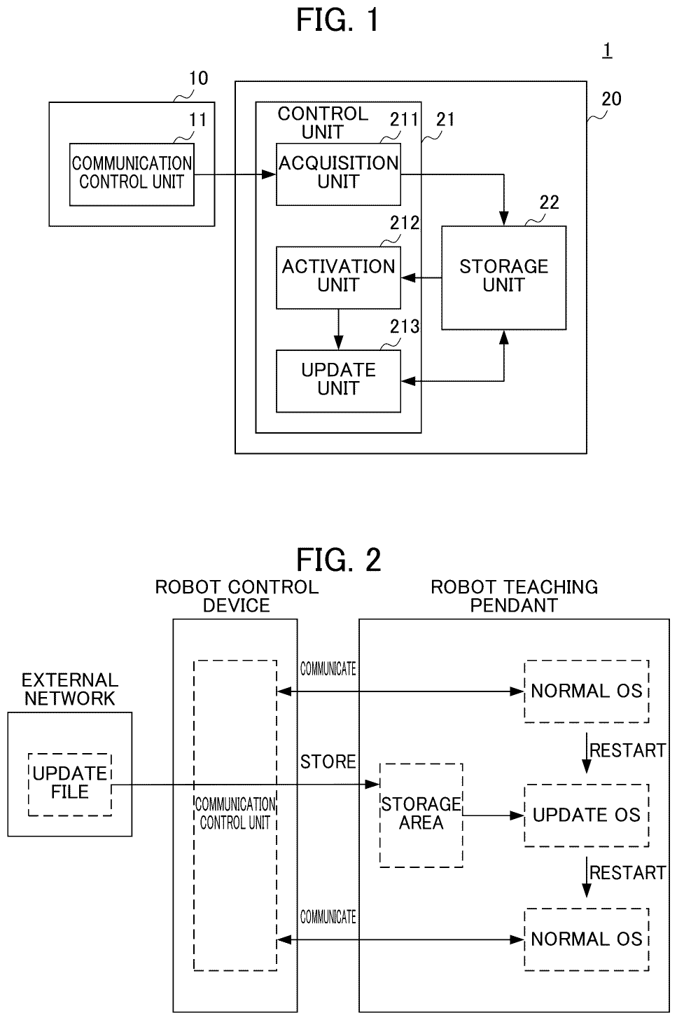

FIG. 1 is a block diagram illustrating a functional configuration of a robot control system 1 according to the present embodiment. The robot control system 1 includes a robot control device 10 connected to a network, and a robot teaching pendant 20 communicably connected only to the robot control device 10.

The robot control device 10 controls the operation of the robot according to a predetermined program and user inputs to the robot teaching pendant 20, and acquires various measurement data and the like from the robot. In addition, the robot control device 10 includes a communication control unit 11 that performs communication with the robot teaching pendant 20 and communication with the network.

In the present embodiment, the communication control unit 11 acquires update data of software executed by the robot teaching pendant 20 from the network in response to a request from the robot teaching pendant 20, and transmits the update data to the robot teaching pendant 20.

The robot teaching pendant 20 is an information processing device (computer) including a control unit 21 (processor) and a storage unit 22 (memory), is communicably connected to the robot control device 10, and provides an interface between the robot control device 10 and a user. The control unit 21 includes an acquisition unit 211, an activation unit 212, and an update unit 213, and these functional units operate by the control unit 21 reading and executing various types of software stored in the storage unit 22.

The acquisition unit 211 acquires update data of software executed by the robot teaching pendant 20 from the network via the robot control device 10. The acquired update data is stored in the storage unit 22. The software to be updated, which is executed by the robot teaching pendant 20, may be an OS or an application program operating on the OS; however, a case of updating the OS will be exemplified herein.

Note that the update data may be acquired, for example, in response to an instruction from the user or periodically, and the acquisition timing may be set as appropriate.

The activation unit 212 activates an update processing program for updating software. When the software to be updated is an OS for normal operation (first OS), the activation unit 212 activates a second OS as an update processing program instead of the OS for normal operation. The second OS is a program for only updating the first OS, and is selectively activated by, for example, an option at the time of restarting the robot teaching pendant 20.

The update unit 213 updates the software (first OS) based on the update data stored in the storage unit 22 in accordance with the update processing program (second OS). Then, the update unit 213 switches to the updated first operating system by restarting the robot teaching pendant 20.

The update data may be an image file of the software (first OS). In this case, the update unit 213 replaces the entirety of the software with the image file. For example, in order to make it possible to repair a software failure, the image file may be continuously retained in the storage unit 22 even after the update processing.

FIG. 2 is a diagram illustrating a flow of processing in which the OS of the robot teaching pendant 20 is updated by the robot control system 1 of the present embodiment. The robot teaching pendant 20 receives the update file from an external network via the communication control unit 11 of the robot control device 10 which is the communication destination, and stores the update file in a predetermined storage area (storage unit 22), during operation by the normal os.

Thereafter, the robot teaching pendant 20 is restarted by the update OS, in place of the normal OS, at a predetermined timing. The update OS does not provide a communication function with the robot control device 10. When the update file in the storage area is checked and the normal OS is updated, the robot teaching pendant 20 is restarted. As a result, the updated normal OS operates, and communication with the robot control device 10 is restored.

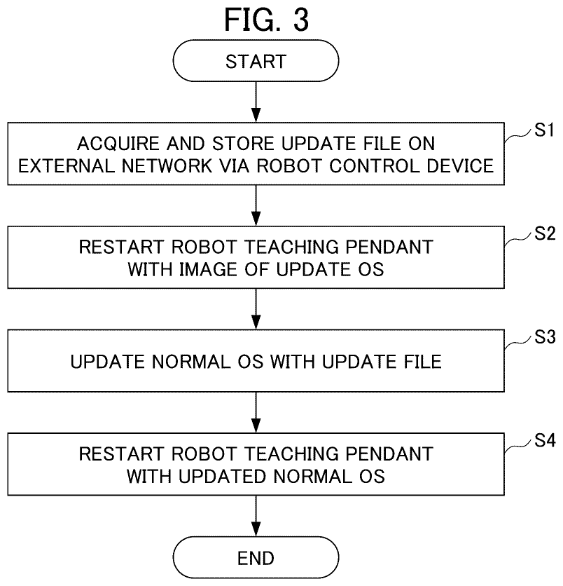

FIG. 3 is a flowchart illustrating software update processing according to the present embodiment. Here, a case is shown where the processing is started by the user's selection and a series of procedures related to the update of the OS is continuously executed.

In step S1, when the user selects to update the OS, the acquisition unit 211 acquires an update file on the external network via the robot control device 10 and stores the update file in the storage unit 22.

In step S2, the activation unit 212 restarts the robot teaching pendant 20 using the image of the update OS stored in advance. Since only the function of updating the normal OS is implemented in the update OS, the connection with the robot control device 10 is lost at this time.

In step S3, the update unit 213 updates the normal OS using the update file stored in step S1.

In step S4, the update unit 213 restarts the robot teaching pendant 20 again using the normal OS updated in step S3. As a result, the connection with the robot control device 10 is restored.

The storage of the update file in step S1 is not limited to this timing, and may be executed in advance regardless of the presence or absence of an instruction from the user.

According to the present embodiment, it is possible for the robot teaching pendant 20 to update the software using the update processing program stored in advance, by acquiring the update data of the software from the network via the robot control device 10 capable of communication. Therefore, it is not necessary to separately store update data or the like in a storage device such as an SD card or a USB memory by a user operation. As a result, it is possible to suppress the risk of update failure or software failure due to an operational error, rewriting by a third party, or the like, and it is possible for the robot teaching pendant 20 to easily and safely update the software. In addition, the update processing program does not leak from the robot teaching pendant 20, and the risk of rewriting by a third party is suppressed by accessing a specific file on the network that is safely managed for the update data.

The robot teaching pendant 20 may replace the entirety of software by storing an image file of the software as the update data. Thus, it is possible for the robot teaching pendant 20 to easily perform rewriting and restoring, for example, when software fails.

The software to be updated may be an OS. In this case, the robot teaching pendant 20 can update the normal OS by restarting using the update OS, and can operate with the updated normal OS by restarting again.

Although embodiments of the present invention have been described in detail above, the present invention is not limited to the individual embodiments described above. Various additions, substitutions, changes, partial omissions, and the like can be made to these embodiments without departing from the gist of the invention, or without departing from the spirit and scope of the present invention derived from the contents described in the claims and equivalents thereof. For example, in the above-described embodiments, the order of operations and the order of processing are shown as an example, and the present invention is not limited thereto.

### EXPLANATION OF REFERENCE NUMERALS

1 robot control system
10 robot control device
11 communication control unit
20 robot teaching pendant
21 control unit
22 storage unit
211 acquisition unit
212 activation unit
213 update unit

1. A robot teaching pendant that communicates only with a robot control device and provides an interface for a user, the robot teaching pendant comprising:
an acquisition unit that acquires update data of software to be executed by the robot teaching pendant from a network via the robot control device;
a storage unit that stores the update data;
an activation unit that activates an update processing program for updating the software; and
an update unit that updates the software based on the update data stored in the storage unit in accordance with the update processing program.

2. The robot teaching pendant according to claim 1, wherein
the storage unit stores an image file of the software as the update data, and
the update unit replaces an entirety of the software with the image file.

3. The robot teaching pendant according to claim 1, wherein
the software is a first operating system for normal operation;
the activation unit activates a second operating system as the update processing program in place of the first operating system, and
after updating the first operating system, the update unit switches the second operating system to an updated first operating system by restarting.

4. A robot control system comprising a robot control device and a robot teaching pendant that communicates only with the robot control device and provides an interface for a user, wherein
the robot control device includes:
a communication control unit that acquires update data of software to be executed by the robot teaching pendant from a network in response to a request from the robot teaching pendant, and transmits the update data to the robot teaching pendant, and
the robot teaching pendant includes:
an acquisition unit that acquires the update data via the robot control device;
a storage unit that stores the update data;
an activation unit that activates an update processing program for updating the software; and
an update unit that updates the software based on the update data stored in the storage unit in accordance with the update processing program.
